(19) United States
(12) Patent Application Publication
(10) Pub. No.: US 2024/0402061 A1
(43) Pub. Date: Dec. 5, 2024

(54) UNIAXIAL-BIAXIAL-TRIAXIAL APPARATUS AND METHOD FOR IN-AIR AND IN-SOIL TESTING OF GEOSYNTHETIC MATERIALS

(71) Applicant: Georgia Tech Research Corporation, Atlanta, GA (US)

(72) Inventors: David Frost, Atlanta, GA (US); Emre Duman, Atlanta, GA (US)

(21) Appl. No.: 18/676,079

(22) Filed: May 28, 2024

Related U.S. Application Data
(60) Provisional application No. 63/469,145, filed on May 26, 2023.

(51) Int. Cl. G01N 3/06; G01B 11/16; G01N 3/08; G06T 7/00; G06T 7/32

(52) U.S. Cl. CPC G01N 3/068; G01B 11/16; G01N 3/08; G06T 7/32; G06T 7/97

(57) ABSTRACT

An exemplary testing system and method are disclosed for mechanical testing and evaluation of geogrids and other geosynthetic materials to improve load distribution, durability, and performance. The exemplary testing apparatus and method are capable of uniaxial, biaxial, and triaxial testing on different geogrids and other geosynthetic building material, including all types of commercially available geogrids (uniaxial, biaxial, triaxial), geotextiles (woven, non-woven), as well as new-generation geogrids (including spider-web inspired that have hexagonal and other multi-scaled structures). The test apparatus can perform static (monotonic) application of load as well as cyclic tests on geosynthetic materials.

### RELATED APPLICATION

The US application claims priority to, and the benefit of, U.S. Provisional Patent Application No. 63/469,145, filed May 26, 2024, which is incorporated by reference herein in its entirety.

### STATEMENT REGARDING FEDERALLY SPONSORED RESEARCH OR DEVELOPMENT

This invention was made with government support under grant no. EEC-1449501 awarded by the National Science Foundation. The government has certain rights in the invention.

### BACKGROUND

Geosynthetics are synthetic products used to stabilize terrain. They are generally polymeric products used to solve civil engineering problems. This includes eight main product categories: geotextiles, geogrids, geonets, geomembranes, geosynthetic clay liners, geofoam, geocells and geocomposites. The polymeric nature of the products makes them suitable for use in the ground where high levels of durability are required.

Geosynthetics are synthetic products (e.g., polymers) used to stabilize terrain in geotechnical and civil engineering for separation, reinforcement, filtration, and drainage. Among geosynthetics, geogrids are used for reinforcement applications and are capable of locking the earth materials in place and thereby augmenting the stability of the system. Geogrids also provide load distribution improvement and a tensioned membrane effect. Various factors that can influence the effectiveness of the geogrid include, for example, its material type, aperture size, and shape. However, existing systems have failed to explore a range of size, shape, and material implementations.

There is a benefit to improving the testing of geogrids and other geosynthetic material.

### SUMMARY

An exemplary testing system and method are disclosed for mechanical testing and evaluation of geogrids and other geosynthetic material to improve load distribution, durability, and performance. The exemplary testing apparatus and method are capable of uniaxial, biaxial, triaxial, and multi-axial testing on different geogrids and other geosynthetic building material, including all types of commercially available geogrids (uniaxial, biaxial, triaxial), geotextiles (woven, non-woven), as well as new-generation geogrids (including spider-web inspired that have hexagonal and other multi-scaled polygonal structures). In addition to static (monotonic) application of load, the test apparatus is also capable of being used to perform cyclic tests on geosynthetic materials (both geotextiles and geogrids) and long-term creep tests.

The exemplary testing device can test geosynthetics, including geogrids with any inherent structure using a single reconfigurable in-plane apparatus where the geosynthetic can either be in-air (thus testing only the response of the manmade materials) or embedded in soil (where the effects of soil-geosynthetic interaction can also be assessed).

The selection of uniaxial, biaxial, tri-axial, and multi-axial tests may be based on the geometric configuration of the geosynthetic material of interest, e.g., to evaluate its lateral confinement performance. The exemplary testing system and method can provide meaningful data in the development of more complex geosynthetic structures.

In an aspect, a testing apparatus for testing geosynthetic structures, the testing apparatus comprising: a test stand (e.g., base table); a set of lateral load-inducing test cells mechanically coupled, directly or indirectly, to the test stand, wherein each set of lateral load inducing test cells comprises a load inducing structure or device (e.g., jack or deadweight), a guide, a load cell, and a clamp, wherein the set of lateral load inducing test cells are configured to couple, via the clamps, to a geosynthetic specimen; and a controller coupled to the load cells of the set of lateral load inducing test cells, wherein the controller is configured to record a load-deformation response of the geosynthetic specimen.

In some embodiments, the testing apparatus further includes a soil box integrated into the test stand, the soil box having a boundary that defines a uniform load-inducing test area for the geosynthetic specimen.

In some embodiments, the testing apparatus further includes a vertical load-inducing test cell positioned over the soil box, the vertical load-inducing test cell being configured to induce a vertical load within the boundary onto the uniform load-inducing test area of the geosynthetic specimen.

In some embodiments, the testing apparatus further includes a contactless deformation measurement system positioned over the uniform load-inducing test area for the geosynthetic specimen.

In some embodiments, the contactless deformation measurement system comprises a camera and a controller configured to perform digital image correlation analysis of two or more images acquired by the camera (e.g., to determine a stress field or displacement field therein).

In some embodiments, the testing apparatus further includes a movable frame having a set of arms, wherein a portion or all of the arms are movable with respect to each other, the set of lateral load-inducing test cells being coupled to an end of an arm.

In some embodiments, the movable frame includes only a first arm, the first arm is configured with one or a pair of lateral load-inducing test cells for uniaxial testing.

In some embodiments, the movable frame further includes a second arm, the second arm being positionable with respect to the first arm, wherein the second arm is configured with a second or a second pair of lateral load-inducing test cells for biaxial testing.

In some embodiments, the movable frame includes a third arm, the third arm being positionable with respect to the first arm and the third arm, the third arm being configured with a third or a third pair of lateral load-inducing test cells for triaxial testing, wherein the first arm includes a center protrusion to receive the second arm and the third arm, wherein the second arm and third arm each have a central hole to be positioned onto the first arm, and wherein the first arm has a first thickness, the second arm has a second thickness, and the third arm having a third thickness to define a flush surface for respective placement of the set of lateral load inducing test cells.

In some embodiments, the second arm and third arm are reconfigurable to different positions.

In some embodiments, the test stand includes a first set of holes or slots to receive one or a pair of lateral load-inducing test cells for uniaxial testing.

In some embodiments, the test stand includes a second set of holes or slots to receive a second or a second pair of lateral load-inducing test cells for biaxial testing.

In some embodiments, the test stand includes a third set of holes or slots to receive a third or a third pair of lateral load-inducing test cells for triaxial testing.

In some embodiments, the soil box has a first geometry (e.g., hexagon) and is a part of a soil box system, the soil box system comprises a set of inserts that can be inserted into soil box to provide a second geometry, wherein the second geometry (e.g., square, circle, oval, rectangle, octagonal, decagonal, dodecagonal, icosaganal) is different from the first geometry.

In some embodiments, the soil box system includes a vertical load frame for a vertical load-inducing test cell comprising a load piston and a load plate to apply loads to the geosynthetic specimen.

In some embodiments, the set of lateral load-inducing test cells is configured to apply loads monotonically (statically) to the geosynthetic specimen.

In some embodiments, the set of lateral load-inducing test cells is configured to apply loads cyclically (dynamically) to the geosynthetic specimen.

In some embodiments, the set of lateral load-inducing test cells comprises dead-weight systems comprising a dead weight, pulley, and cable (e.g., for long-term creep testing of specimens under uniaxial, biaxial, triaxial or multiaxial load conditions).

In some embodiments, the soil box includes natural geomaterial above and below the geosynthetic specimen.

In some embodiments, the soil box includes man-made synthetic geomaterial (foam/rubber) above and below to geosynthetic specimen to investigate fundamental mechanisms.

In some embodiments, the geosynthetic specimen is shaped to include a central region to be positioned in the soil box and an extension region that extends from the central region.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF DRAWINGS

FIG. 1 shows an example testing system configured to evaluate lateral confinement performance of a geosynthetic lateral confinement structure, such as geogrids, in accordance with an illustrative embodiment.

FIG. 2 shows an example lateral load-inducing test cell of FIG. 1, and components thereof, in accordance with an illustrative embodiment.

FIG. 3A shows an example method of test setup and testing in accordance with an illustrative embodiment.

FIGS. 3B-3F each show configurations for a shaped geosynthetic specimen that may be evaluated using the test system.

FIG. 3G shows another example method of test setup and testing in accordance with an illustrative embodiment.

FIGS. 4A, 4B, 4C each shows a uniaxial test, a biaxial test, and a tri-axial test, respectively, using the lateral load-inducing test cells in accordance with an illustrative embodiment.

FIG. 4D shows a tri-axial test using lateral load-inducing test cells comprising dead weights in accordance with an illustrative embodiment.

FIGS. 4F, 4G, 4H each shows another example of the lateral load-inducing test cells and test assembly having movable frames in accordance with an illustrative embodiment.

FIGS. 4I, 4J, 4K show an example assembly of the system of FIG. 4F comprising the lateral load-inducing test cells and test assembly having movable frames in accordance with an illustrative embodiment.

FIG. 5A shows a test setup with a contactless deformation measurement system.

FIG. 5B shows the measurement from a digital image correlation analysis acquired by the contactless deformation measurement system.

### DETAILED DESCRIPTION

The details of one or more embodiments of the invention are set forth in the accompanying drawings and the description below. Other features, objects, and advantages of the invention will be apparent from the description and drawings and from the claims.

Throughout the description and claims of this specification, the word “comprise” and other forms of the word, such as “comprising” and “comprises,” means including but not limited to, and is not intended to exclude, for example, other additives, components, integers, or steps.

To facilitate an understanding of the principles and features of various embodiments of the present invention, they are explained hereinafter with reference to their implementation in illustrative embodiments.

### Example System

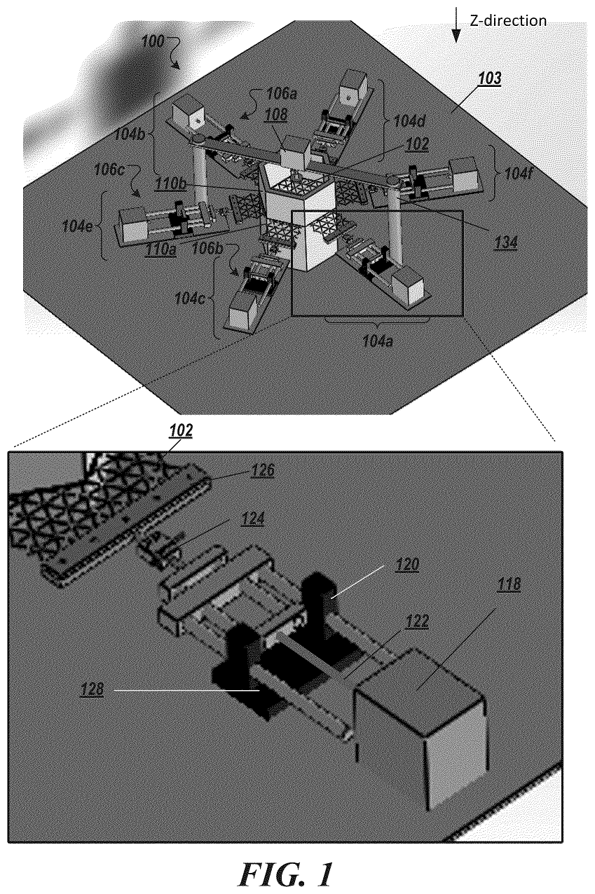

FIG. 1 shows an example testing system 100 configured to evaluate lateral confinement performance of a geosynthetic lateral confinement structure 102 (also referred to as a sample 102 or specimen 102), such as geogrids, in accordance with an illustrative embodiment. The testing system 100 includes a set of lateral load-inducing test cells 104 (shown as 104a, 104b, 104c, 104d, 104c, and 104f) configured in pairs 106 (shown as 106a, 106b, 106c) to test the geosynthetic lateral confinement structure 102, in a uniaxial test, a biaxial test, and/or a triaxial test. The pairing allows a more uniform load to be applied to the sample 102 in applying to a center axis that is centered to the sample.

The sample or specimen 102 comprises a geosynthetic, which is a synthetic product, used to stabilize terrain. Geosynthetics are generally polymeric products used to solve civil engineering problems. This includes eight main product categories: geotextiles, geogrids, geonets, geomembranes, geosynthetic clay liners, geofoams, geocells, and geocomposites. The polymeric nature of the products makes them suitable for use in the ground where high levels of durability are required.

In the example shown in FIG. 1, the sample 102 is retained in soil box 110, with a portion of the sample 102 extending from the soil box 110 to be connected to the set of lateral load-inducing test cells 104. The set of lateral load-inducing test cell 104, and in some embodiments can uniformly assert a load on a portion of the geosynthetic lateral confinement structure 102 located in the soil box 110 while if desired the vertical load inducing test cell 108 asserts a vertical force/load on the same portion.

In a uniaxial test, a pair 106a comprising two lateral load-inducing test cells 104a, 104b are employed, e.g., along with the vertical load inducing test cell 108; the pair is on opposing side from each other. In a biaxial test, two pair 106a, 106b comprising four lateral load-inducing test cell 104a, 104b, 104c, 104d are employed, e.g., along with the vertical load-inducing test cell 108; the pairs individually is on opposing sides from each other and also orthogonal/perpendicular to each other. In some embodiments, the angle of the pairs of lateral load-inducing test cell 104 can be defined by the geometric shape of the sample 102 (which may be angled to provide lateral confinement performance in a pre-defined direction. In a triaxial test, three pair 106a, 106b, 106c comprising six lateral load-inducing test cells 104a, 104b, 104c, 104d, 104c, 104f are employed, e.g., along with the vertical load-inducing test cell 108.

The testing system 100 may additionally include a vertical load inducing test cell 108 to provide a vertical load the sample or contents of the soil box 110.

The testing system 100 may additionally include a contactless measurement system 109.

In the example shown in FIG. 1, the testing apparatus 100 (for a tri-axial test) includes a base table 112 that remove-ably mounts the six lateral load-inducing test cells 104a, 104b, 104c, 104d, 104c, 104f at six radial positions surrounding the soil box 110. In one embodiment, the base table 112 includes a hollow portion for placement of the soil box 110. The soil box 110 includes (i) a bottom portion 110a, e.g., fixably mounted to the base table 112 or a structure to which the base table 112 is also fixable attached, and (ii) a top portion 110b to seat over the bottom portion 110a. The top portion 110a is removable to allow (i) the sample 102 and (ii) geo-material 114 (e.g., soil, sand, clay, aggregates, or manmade simulants of the same) (not shown) to be placed in the soil box 110 for the assessment of the sample 102 in such geo-material 116. In the view of FIG. 1, the base table 112 is shown as a plane to illustrate both the top and bottom portions 110a, 110b of the soil box 110.

In the example shown in FIG. 1, each lateral load-inducing test cell 104 (shown as 104a′) includes a jack 118, guide 120, shaft 122, load cell 124, and clamp 126.

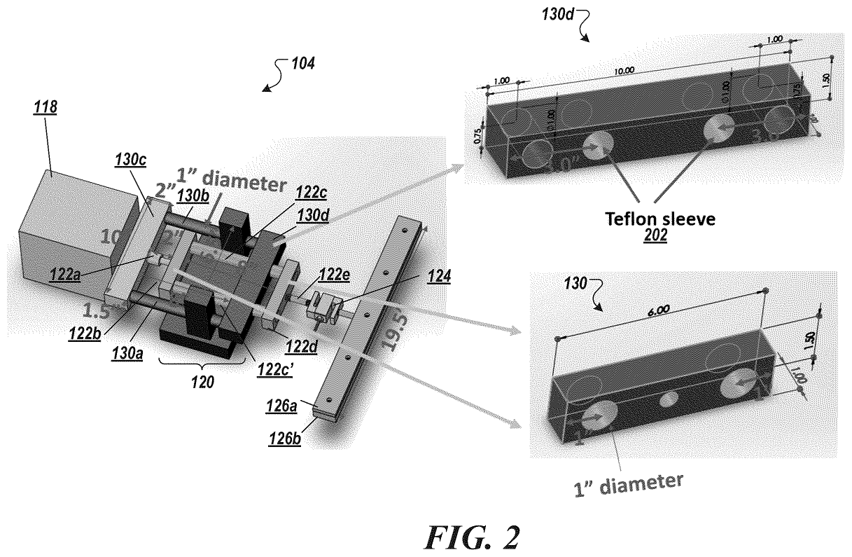

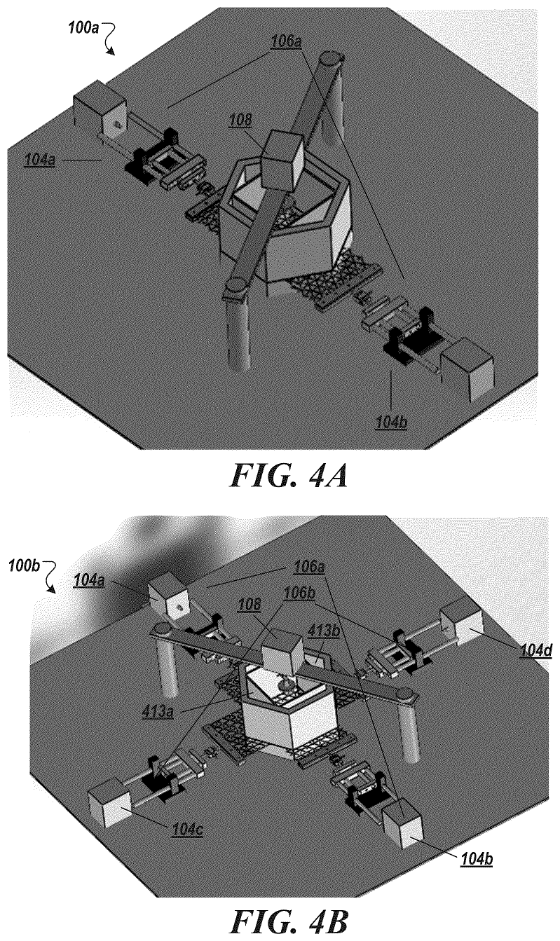

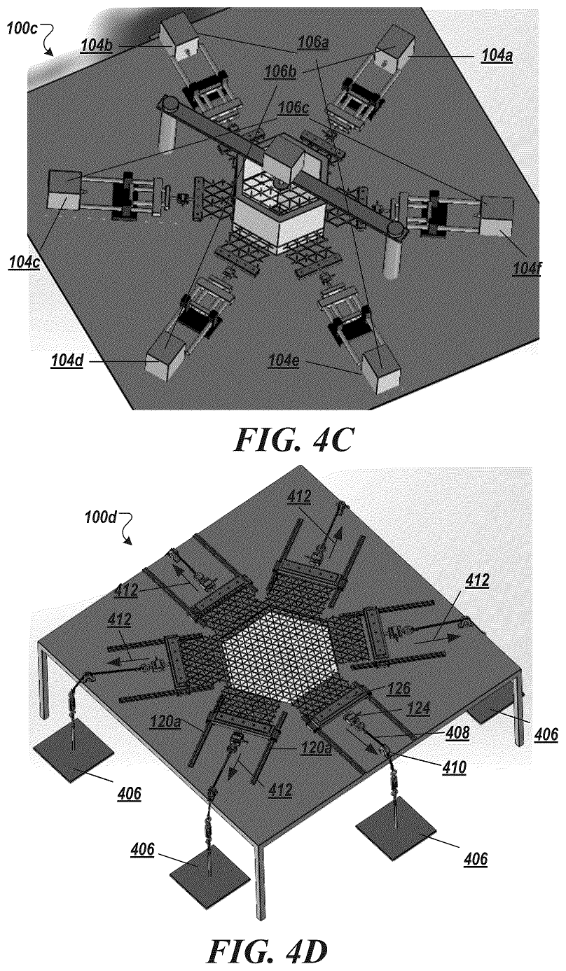

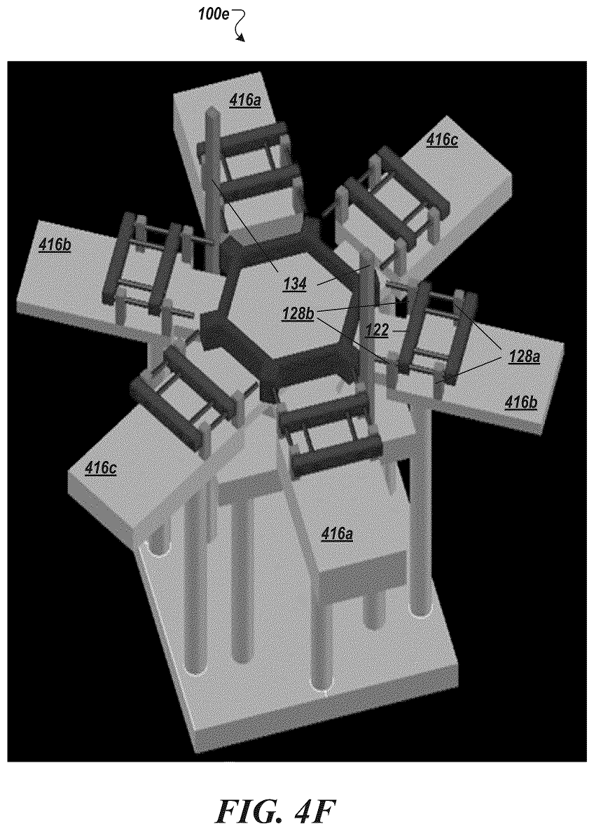

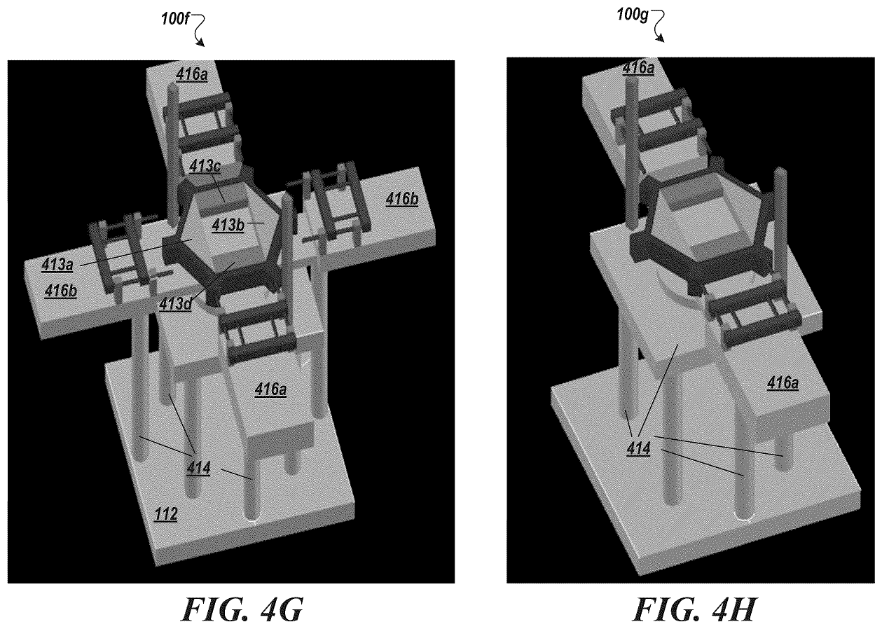

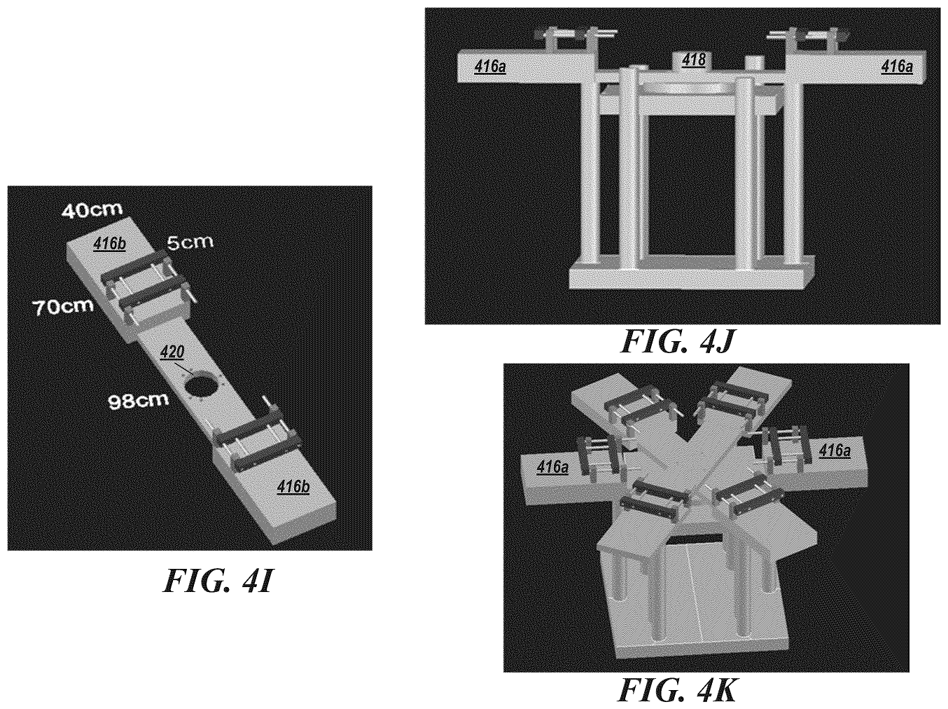

FIG. 2 shows a detailed view of the same with example dimensions. Other configurations are shown, e.g., in FIGS. 4C and 4D.

Base table. The base table 112 is a mounting platform for mounting of the instruments and includes at least one set of mounting holes for lateral load-inducing test cells 104. In some embodiments, the base table 112 includes multiple sets of mounting holes to allow for multiple mounting configurations, e.g., 2, 4, 6, 8 devices and a defined angle or at different angles. In some embodiments, the base table 112 includes slots for multiple mounting configurations. The base table 112 may be a steel table, e.g., an optical table or other vibration control platform having pre-defined mounting holes or slots.

In some embodiments, the base table 112 may be configured with a heat or cool box (e.g., LEXAN or see-through casing) to form a chamber over the test setup, e.g., to heat or cool the sample 102.

Jack. The jack 118 can be a mechanical jack (manual), pneumatic jack (automatic), motor, or dead weight to provide a load-inducing force to the sample 102 through the device. The jack 118 (except for the dead weight) is preferably mounted in a fixable manner through the guide 120 to the base table 112. In some embodiments, the jack 118 can be replaced with a dead weight that is coupled to a steel wire.

Guide. The guide 120 preferably includes a bearing 202 (shown as “teflon sleeve” 202 in FIG. 2) that engages with the shaft 122 (e.g., shaft part 122c, 122c′) connected to the jack 118 to allow the shaft to move between a loaded position and an unloaded position. Other bearings can be used. The guide 120 is fixably connected, e.g., via a guide base 128, to the base table 112. In the example shown in FIG. 2, the guide 120 includes a guide assembly having alignment connectors 130 formed of two shafts 130a, 130b, and two bilateral connectors 130c, 130d. The shaft 122 (shown having a shaft connector 122a, bilateral member 122b, arm members 122c, 122c′, bilateral member 122d, clamp connector 122e) is configured to move between a first set of positions and a second set of positions through the bearings of the guide 120.

FIG. 4D shows another configuration of the guide 120 (shown as 102b) having two pairs of guide base 128 (shown as 128a, 128b) for each of the lateral load-inducing test cell 104.

FIG. 4C shows another configuration of the guide 120 (shown as 120a) in which the guide 120a fixably connects to the base table 112 and forms linear guides for dead weights to translate/move along a pre-defined axis/direction.

Load cell. The load cell 124 is a force transducer configured to convert a force such as tension, compression, pressure, or torque into an electrical signal. The load cell 124 may be a pneumatic, hydraulic, or strain gauge type and couples to a measurement instrument configured to provide a measurement (e.g., tension, compression, pressure, or torque) to a datalogger.

Clamp. The clamp 126 is configured to couple the sample 102 to the lateral load inducing test cell 104. In the example shown in FIG. 2, the clamp 126 includes a top portion 126a and a bottom portion 126b having a set of holes to which connectors (e.g., nut and bolt) can be attached. The nut and/or bolt may be tightened to a pre-defined torque to provide a uniform and calibrated grip on the sample 102.

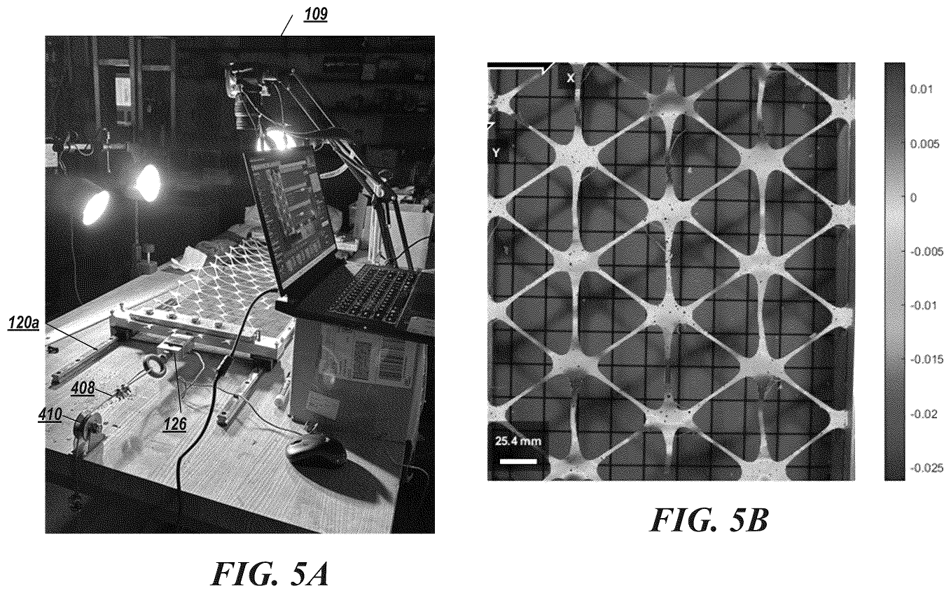

Contactless instrumentation. The contactless deformation measurement system 109 (not shown, see FIG. 5A) may be employed comprising a camera configured to capture two or more images of the specimen under different loads for digital image correlation. Digital image correlation and tracking is an optical method that employs tracking and image registration techniques for accurate 2D and 3D measurements of changes in images. The base table 112 may be employed in combination with a shroud having a light reflective surface to provide uniform lighting to the camera system.

The testing system 100 may employ other contactless measurement system, e.g., a laser interferometry system configured to project interference patterns that contain information about the object or phenomenon.

Inserts/Adapters for soil box. The soil box 110 may be reconfigurable for different-shaped specimens using inserts that can convert the internal geometry of the soil box 110, e.g., from a hexagon, to a square or rectangle. In FIG. 4B, two inserts 413 (shown as 413a, 413b) are dimensioned to be placed within the soil box 110. FIGS. 4G and 4H show another configuration with four inserts 413 (shown as two triangular sections 413a, 413b, and two rectangular sections 413c, 413d) being employed.

Datalogger. Datalogger is an instrument configured to measure pressure/intrinsically safe, bridge/strain, and/or shock/vibration, e.g., from the load cell. The instrument may be configured for sampling between 1 Hz and 100 Hz. In some embodiments (e.g., for creep test), the instrument may be configured for longer durations, e.g., minute or hourly measurements or longer.

Table 1 shows an example measurement test that can be performed and the associated test.

TABLE 1

| | | Test Applied | |
|---|---|---|---|
| Example Test | | Force | Description |
| Stress, strain | In air | Uniaxial, | Pull sample to determine |
| | | biaxial, or | stress-strain curve for |
| | | tri-axial test | sample |
| | In soil or | Uniaxial, | Pull sample to determine |
| | simulant | biaxial, or | stress and strain curve for |
| | | tri-axial test | lateral retainment capability |
| | | | of specimen in soil |
| Strength | In air | Uniaxial, | Pull sample to determine |
| | | biaxial, or | maximum force that causes |
| | | tri-axial test | deformation |
| | In soil or | Uniaxial, | Pull sample to determine |
| | simulant | biaxial, or | maximum force maintained |
| | | tri-axial test | by lateral retainment |
| | | | capability of specimen in |
| | | | soil |
| Deformation | In air | Uniaxial, | Pull sample at pre-defined |
| response | | biaxial, or | force to determine resulting |
| | | tri-axial test | deformation |
| | In soil or | Uniaxial, | Pull sample at pre-defined |
| | simulant | biaxial, or | force to determine resulting |
| | | tri-axial test | deformation in the |
| | | | specimen and displacement |
| | | | of soil |
| Creep | In air | Uniaxial, | Apply normal or elevated |
| | | biaxial, or | force to the sample for an |
| | | tri-axial test | extended duration to |
| | | | measure creep |
| | In soil or | Uniaxial, | Apply normal or elevated |
| | simulant | biaxial, or | force to the sample for an |
| | | tri-axial test | extended duration to |
| | | | measure the creep of the |
| | | | specimen and soil system |
| Surface rutting | In soil or | Uniaxial, | Apply multiple load cycles |
| | simulant | biaxial, or | to soil surface to evaluate |
| | | tri-axial test | surface deformations and |
| | | | geosynthetic efficacy in |
| | | | reducing them |
| Cyclic loading | In air | Uniaxial, | Evaluate stiffness |
| | | biaxial, or | degradation of geosynthetic |
| | | tri-axial test | under repeated load cycles |
| Geosynthetic- | In man-made | Uniaxial, | Evaluate interaction |
| geomaterial | geomaterial | biaxial, or | between different |
| interactions | | tri-axial test | geosynthetics and man- |
| | | | made geomaterials (foam/ |
| | | | rubber) to identify |
| | | | fundamental interaction |
| | | | mechanisms |

Vertical load testing. FIG. 1A additionally shows the vertical load inducing test cell 108 to provide a vertical load on the sample or contents of the soil box 110. The vertical load-inducing test cell 108 is fixably coupled with a support structure 134 that mounts to the base table 112 at two or more locations to provide a mounting location for the vertical load-inducing test cell 108 above the soil box 110. The vertical load-inducing test cell 108 may include a mechanical jack (manual), pneumatic jack (automatic), motor, or dead weight to provide a load-inducing force in a z-direction into the sample 102.

Variable-shaped specimens. In physical modeling in geotechnical engineering, stress distribution is a consideration as improper distribution (e.g., when the load application axes are not aligned with the primary structure of the material) can lead to misinterpretation of the true capacity or capability of a geosynthetic. Usage of shaped specimens having removed excess material not aligned with the primary test structure (and the associated loading test) can remove or reduce distortion of a geogrid and geosynthetic sample as the shaped specimens can reduce the portions of the sample subject to a load, to provide a more uniform stress distribution in the interior portion of the specimen.

The testing apparatus may perform tests on all types of commercially available geosynthetics, including geogrids (uniaxial, biaxial, triaxial), geotextiles (woven, non-woven) as well as new-generation geogrids (including spider-web inspired that have hexagonal and other multi-scaled structures). In addition to static (monotonic) application of load, the test apparatus is also capable of being used to perform cyclic tests on geosynthetic materials (both geotextiles and geogrids).

The exemplary testing device (e.g., 104, 108) is designed to enable testing of geogrids and other geosynthetics with any inherent structure using a single reconfigurable in-plane apparatus where the geosynthetic can either be in-air (thus testing only the response of the manmade materials) or embedded in soil (where the effects of soil geosynthetic interaction can also be assessed).

In one implementation, the exemplary uni-bi-tri axial testing apparatus is provided to efficiently test geosynthetics such as geogrids and geotextiles in-plane using a single reconfigurable apparatus to find both their in-air properties (modulus, strength, deformation) as well as their load-deformation response when embedded in the soil. The proposed apparatus design and method enables users to conduct uniaxial, biaxial, triaxial, and multi-axial testing with geosynthetic materials that have different fundamental structures and strengths, including uniaxial, biaxial, and triaxial structure characteristics and behavior. While simpler devices do exist to either test uniaxial or biaxial structured materials, they are limited to testing only one configuration in-air. Furthermore, they cannot test or evaluate the interaction between the uniaxial and biaxial structured materials and their load-deformation response when embedded in soils. In contrast, the devices, systems, and methods shown in relation to FIG. 1 and described herein can test and evaluate the interaction between the uniaxial, biaxial, and triaxial structured materials and their load-deformation response when embedded in soils.

### Example Method of Setup and Testing

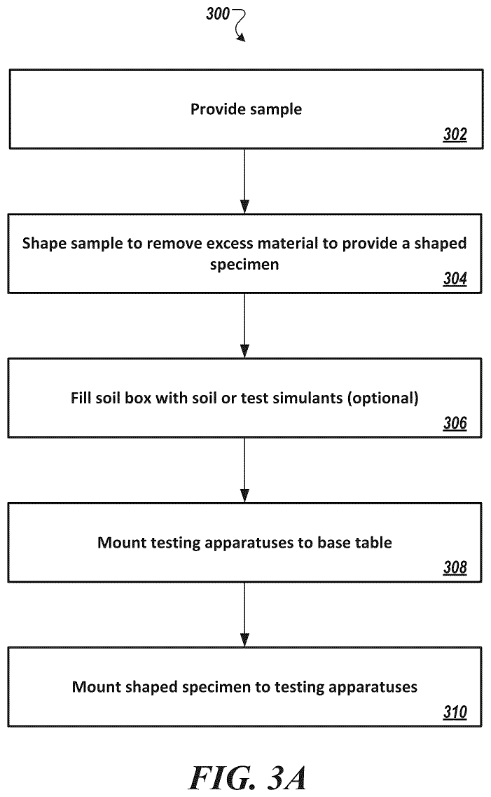

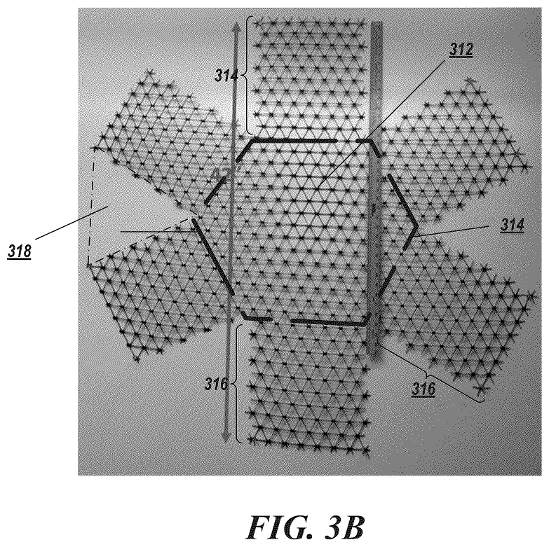

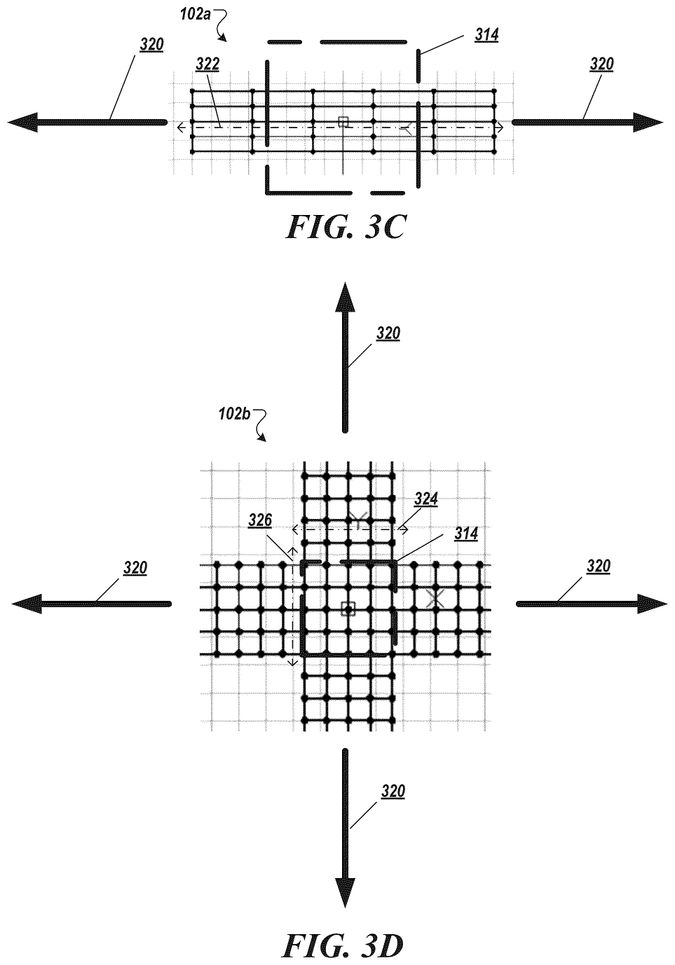

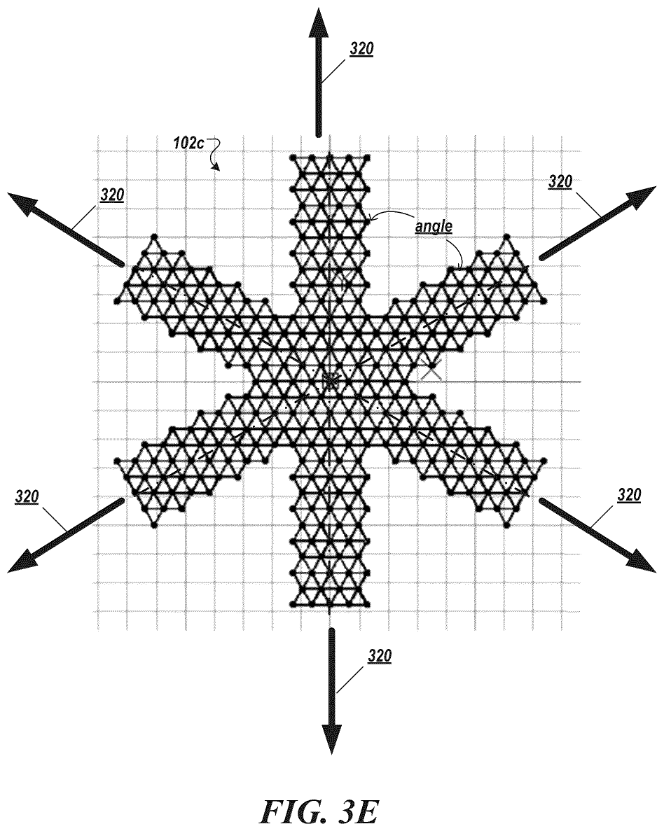

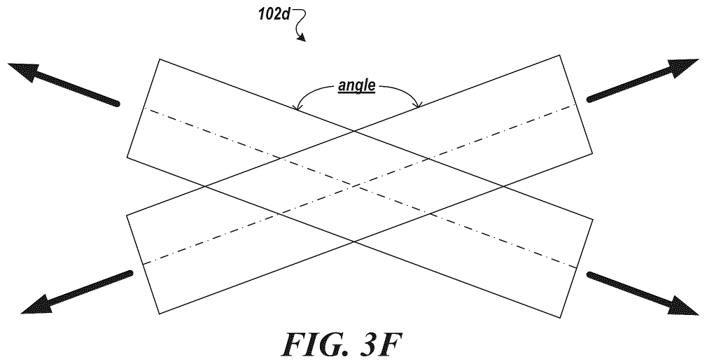

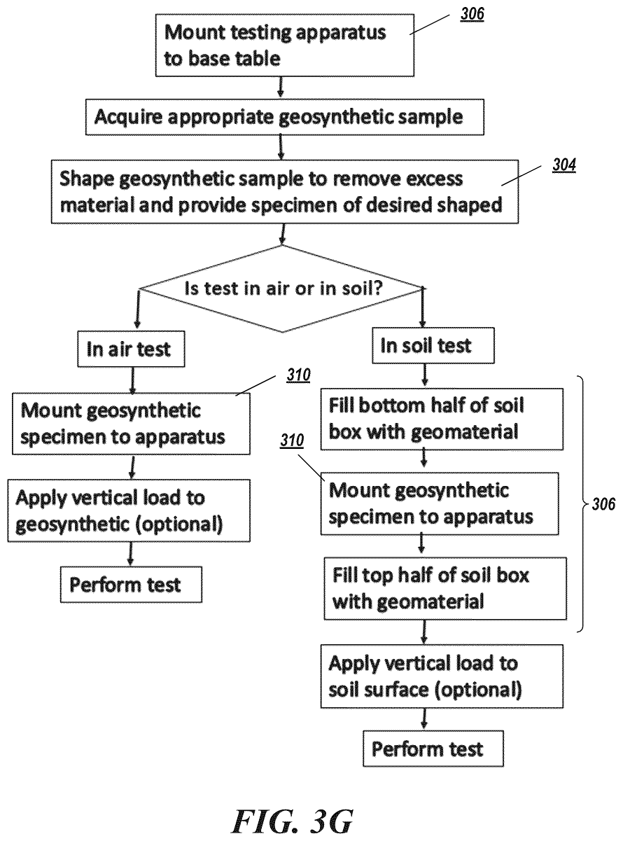

FIG. 3A shows an example method 300 of test setup and testing in accordance with an illustrative embodiment. FIG. 3G shows an alternative method to perform the test setup and testing in accordance with an illustrative embodiment. Method 300 includes providing (302) a sample (e.g., 102), e.g., a geogrid, geotextiles, or other geosynthetic.

Method 300 includes shaping (304) the sample (e.g., 102) to remove excess material not aligned with the primary test structure (and the associated loading test). In some embodiments, the sample (e.g., 102) can be shaped, e.g., by cutting or sheering. FIGS. 3B-3F each show configurations for a shaped geosynthetic specimen that may be evaluated using the test system (e.g., 100).

Method 300 includes, optionally, filling (306) the soil box (e.g., 110) with soil or test simulants. In some embodiments, the soil or test simulants can include natural soil, natural sand, natural clay, natural aggregates, or manmade simulants (e.g., polymers) that have size corresponding to the same.

Method 300 includes mounting (308) the test apparatuses (e.g., lateral load-inducing test cell 104) for the test of interest, e.g., uniaxial test, biaxial test, or tri-axial test. In some embodiments, the base table (e.g., 110) includes a plurality of mounting holes or slots located at various radial positions for mounting the guide base 128 and/or jack 118.

Method 300 includes mounting (310) the sample (e.g., 102) in the soil box (e.g., 110). In some embodiments, e.g., for a test involving the assessment of lateral confinement by the sample, the soil box (e.g., 110) is filled with natural soil, aggregate geomaterial (e.g., in-soil testing), or manmade simulant materials (e.g., foam rubber or similar) having pre-defined mechanical properties and size. In some embodiments, e.g., for stress or load evaluation, the soil box (e.g., 110) may be empty and provide a space for the sample to be mounted.

Testing may be performed, e.g., for load or stress testing, creep test, e.g., for mechanical properties (e.g., modulus, strength, deformation) or for the specimen deformation response. In some embodiments, a contactless deformation measurement system is employed comprising a camera configured to capture two or more images of the specimen under different loads for digital image correlation. Digital image correlation and tracking is an optical method that employs tracking and image registration techniques for accurate 2D and 3D measurements of changes in images. This method is often used to measure full-field displacement and strains, and it is widely applied in many areas of science and engineering. A two-dimensional discrete cross-correlation rᵢⱼ can be determined, e.g., per Equation 1.

$$\\ \begin{matrix}{r}_{ij} = \frac{{\sum }_{m} {\sum }_{n} [ f ( m + i , n + j ) - \overline{f} ] [ g ( m , n ) - \overline{g} ]}{\sqrt{{\sum }_{m} {{{\sum }_{n} [ f ( m + i , n + j ) - \overline{f} ]}^{2} [ g ( m , n ) - \overline{g} ]}^{2}}} & ( Eq . 1 )\end{matrix}$$

In Equation 1, f(m, n) is the pixel intensity or the gray-scale value at a point (m, n) in a baseline image, g(m, n) is the gray-scale value at a point (m, n) in a second image loaded differently from the baseline image, f̅ and g̅ are mean values of the intensity matrices f and g, respectively. Other methods of calculating the field displacement and strains may be used, e.g., via Fourier based methods.

### Example Shaped Geosynthetic Specimens

FIGS. 3B-3F each show configurations for a shaped geosynthetic specimen that may be evaluated using the test system 100. FIG. 3B shows a shaped specimen that was prepared for a tri-axial testing. The specimen 102 includes a central portion 312 to be under test and configured to be position in the soil box 110. The line 314 shows an outline of the soil box 110. The specimen 102 includes extension portion 316 for connection to the lateral load-inducing test cell 104 (e.g., via clamps 128). The extension portions 316 allow for the connection while having excess material removed 318 that is out of axis with the applied testing force. As noted above, usage of shaped specimens having removed excess material not aligned with the primary test structure (and the associated loading test) can remove or reduce distortion of a geogrid and geosynthetic sample as the shaped specimens can reduce the portions of the sample subject to a load, to provide a more uniform stress distribution in the interior portion of the specimen.

The geosynthetic sits on top of the soil in the bottom half of the soil box and then once it is attached to the clamps, the rest of the soil can be placed in the upper half of the box. The top of the soil box can have a set screws to provide an offset of the top portion from the bottom portion to which the specimen can be seated without being restricted. Once the soil box is filled with aggregates, the gap formed by the set screw is filled with the aggregate which provide a continuous layer of geo-material for the testing. Subsequently, the set screws can be withdrawn. The configuration mimics the field construction process and results in the geosynthetic being in intimate contact with soil both below and above it in the testing environment.

FIGS. 3C, 3D, 3E, and 3F each show shaped specimen 102 (shown as 102a, 102b, 102c, 102d) for uniaxial and biaxial test and the corresponding applied force 320. As noted, the selection of uniaxial, biaxial, and tri-axial tests may be based on the geometric configuration of the geosynthetic material of interest, e.g., to evaluate its lateral confinement performance. In FIG. 3C, the specimen 102a is shaped in a geometry corresponding to its internal structure having any elongated portion to laterally retain soil, clay, aggregates, or earth in a primary direction (322). In FIG. 3D, the specimen 102b is shaped in a geometry corresponding to its internal structure having any uniform square grid to laterally retain soil, clay, aggregates, or earth in two primary directions (324, 326). In FIG. 3E, the specimen 102c is shaped in a geometry corresponding to its internal structure having a set of alternating triangular grids to laterally retain soil, clay, aggregates, or earth in three primary directions (328, 330, 332) that are 60 degrees offset from each other. Other specimen and testing configurations may be employed, e.g., 45 degrees for 8 pairs of testing apparatuses 102, 36 degrees for 10 pairs of testing apparatuses. 30 degrees for 12 pairs of testing apparatuses, among others. In FIG. 3F, the specimen 102d is shaped in a geometry corresponding to its internal structure, having a prism geometric configuration to laterally retain soil, clay, aggregates, or earth in a range of directions.

### Additional Examples of Uniaxial, Biaxial, Tri-axial Test Device and Assembly

FIGS. 4A, 4B, 4C each shows a uniaxial test, a biaxial test, and a tri-axial test, respectively, using the lateral load-inducing test cells 104. In FIG. 4A, the uniaxial test is shown using a system 100a having a pair 106a of two lateral load-inducing test cells 104a, 104b. In FIG. 4B, the biaxial test is shown using a system 100b having two pairs 106a, 106b of four lateral load-inducing test cells 104a, 104b, 104c, 104d. In FIG. 4C (similar to FIG. 1), the triaxial test is shown using a system 100c having three pairs 106a, 106b, 106c of six lateral load-inducing test cells 104a, 104b, 104c, 104d, 104c, 104f. Each of the pairs is 120 degrees offset from each other, and individual test cells 104 are 60 degrees offset from each other.

Fix configuration. While FIGS. 4A, 4B, and 4C show pairing of the lateral load-inducing test cells 104 for the uniaxial test, a biaxial test, and a tri-axial test, respectively, it is contemplated that one side of each of the pairs could be fixably mounted without actuation. In that configuration, only one lateral load-inducing test cell may be used per axial test.

The pairing allows more straightforward centering of the apparatus around the soil box, e.g., when the soil box is filled with test material. For in-air testing, the single lateral load-inducing test cells (rather than a pair) can be used to provide a similar uniaxial test, a biaxial test, and a tri-axial test.

Deadweight configuration (creep test). FIG. 4D shows a tri-axial test using lateral load-inducing test cells 104 (shown as 404) comprising dead weights. In the example shown in FIG. 4D, the lateral load-inducing test cells 404 each includes the linear guides 120a fixably mounted to the base table 112 to allow deadweight 406 connected via cables 408 over a pulley 410 to translate/move along a pre-defined axis/direction 412. In some embodiments, a vertical load can be applied, e.g., a weight (not shown) can be placed over the specimen in the center region of the soil box 110.

Lateral load-inducing test cells on movable frames. FIGS. 4F, 4G, 4H each shows another example of the lateral load-inducing test cells 104 (shown as 104d) and test assembly 100 (shown as 100c, 100f, 100g) having movable frames. In FIGS. 4F, 4G, 4H, the system 100c, 100f, 100g, for uniaxial, biaxial, and triaxial, each includes the base table 112, a connecting frame 414 for mounting a set of arms (three arms 416a, 416b, 416c in FIG. 4F) that mounts the lateral load inducing test cells 104d. The arms 416a, 416b, 416c, or a portion thereof, are repositionable and reconfigurable to move with respect to each other to allow the angle of the lateral load inducing test cells 104d to be changed. In FIGS. 4F, 4G, 4H, each end of the arms (e.g., 416a, 416b, 416c) includes the testing apparatus 104d (not shown) comprising the jack 418 (e.g., stepper motor, not shown), guide 120a (having guide bases 128a, 128b), shaft 122, load cell 124 (not shown), and clamp (not shown) to enable the load application and clamp movement. In some embodiments, the apparatus is configured with multiple load cells 124 and displacement transducers to fully record the load, e.g., deformation response irrespective of the specific test configuration (uniaxial, biaxial or triaxial).

Triaxial test configuration. FIG. 4J (another view of FIG. 4F) shows a central arm (e.g., 416a) that couples to the base table 112 through the metal frame 414 (shown having 6 supporting members), the central arm 416a includes a cylindrical protrusion or key 418 for placement of the other two side arms (e.g., 416b, 416c). The side arms (416b, 416c) include a hole 420 (FIG. 4I) for placement onto the central arm 416a. Once placed, the arms 416a, 416b, 416c provide surfaces that are flush with respect to each other. FIG. 4K shows the assembled view of the three arms 416a, 416b, 416c, e.g., in having a different arm thickness.

The test system 100f (as well as 100g, 100h) may include a vertical load-inducing test cell 108 (shown by the frame 134).

The central arm 416a and the other arms 416b, 416c are designed to be easily installed and uninstalled. If only one of the longer frames is attached to the cylindrical core, the system is suitable for uniaxial testing because there are only two end clamps on the testing apparatus. If there are two of the longer frames and they are aligned perpendicular to each other, the system is now suitable for biaxial testing (4 clamps). If all three of the frames are attached to the cylindrical core, and oriented in a way that all of them are 120 degrees to one another, the system is now suitable for triaxial testing (6 clamps). For geogrid structures other than uniaxial, biaxial, and triaxial, the system can be configured with frames at other orientations to apply load to a test specimen in preferred orientations dictated by the structure of the test specimen. Depending on the type of geogrid (uniaxial, biaxial, triaxial), the testing device and method may need to be adjusted.

To ensure symmetry, in some embodiments, the stepper motor of the central arm may be placed at a bottom end, to make it the same elevation as the other stepper motors of the other arms 416b, 416c. This results in all the load application systems being in the same plane, and thus no undesired distortion is applied to the geosynthetic being tested.

Biaxial test configuration. In FIG. 4G, two arms with two sets of lateral load-inducing test cells 104d are employed for the biaxial test. The central arm 416a includes a cylindrical protrusion or key 418 for placement of other arms (e.g., 416b).

Uniaxial test configuration. In FIG. 4H, one arm 416a with one set of lateral load-inducing test cells 104d is employed for the uniaxial test.

Different views (top, front, and isometric) of the reconfigurable testing apparatus (e.g., 100a, 100b, 100c, 100d, 100c, 100f, 100g) and different shaped specimens (102a, 102b, 102c, 102d) are depicted. The scale of the drawings should not limit the potential size of the next generation, including spider-web-inspired geogrids. Nor are these drawings intended to show exactly the form of the apparatus. They are, rather, to illustrate the concept of the apparatus for testing geogrids with different configurations, including spider-web-inspired geogrids.

### Experimental Results and Additional Examples

A study was conducted to develop and evaluate geogrids and other geosynthetics and testing system for the same. FIG. 5A shows a prototype system 500 built in the study having the reconfigurable uniaxial, biaxial, and tri-axial testing capability described in relation to FIG. 1. In FIG. 5A, the prototype system is configured for uniaxial testing having a deadweight configuration, e.g., as shown in relation to FIG. 4D.

The prototype system 500 is shown with the contactless measurement system 109 comprising a camera fixable mounted with a field of view at a test region. The camera is coupled to a computing device (shown as a laptop) configured to store images, e.g., for Digital image correlation analysis.

FIG. 5B shows an example DIC image from a DIC analysis conducted from two or more images acquired using the equipment. To prepare the samples for DIC, the sample/specimen may be spray painted white (or other opaque color).

### Example Computing Device

The methods described herein can be implemented using a computing device. It should be understood that the example computing device described herein is only one example of a suitable computing environment upon which the methods described herein may be implemented. Optionally, the computing device can be a computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In a configuration, a computing device includes at least one processing unit and system memory. Depending on the configuration and type of computing device, system memory may be volatile (such as random-access memory (RAM), non-volatile (such as read-only memory (ROM), flash memory, etc.), or some combination of the two. The processing unit may be a standard programmable processor that performs arithmetic and logic operations necessary for the operation of the computing device. The computing device may also include a communication bus or other communication mechanism for communicating information among various components of the computing device.

Computing device may have additional features/functionality. For example, computing device may include additional storage such as removable storage and non-removable storage, including, but not limited to, magnetic or optical disks or tapes. Computing device may also contain network connection(s) that allow the device to communicate with other devices. Computing device may also have input and output means such as a keyboard, mouse, touch screen, a display, speakers, printer, etc. The additional devices may be connected to the communication bus in order to facilitate the communication of data among the components of the computing device. All these devices are known in the art and need not be discussed at length here.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Examples of tangible, computer-readable media may include, but is not limited to, volatile media, non-volatile media, removable media, and non-removable media implemented in any method or technology for storage of information such as computer-readable instructions, data structures, program modules, or other data. System memory, removable storage, and non-removable storage are all examples of tangible, computer storage media. Examples of tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example embodiment, the processing unit may execute program code stored in the system memory. For example, the communication bus may carry data to the system memory, from which the processing unit receives and executes instructions. The data received by the system memory may optionally be stored on the removable storage or the non-removable storage before or after execution by the processing unit.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

It should be appreciated that the logical operations described above and, in the appendix, can be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.

What is claimed:

1. A testing apparatus for testing geosynthetic structures, the testing apparatus comprising:
a test stand;
a set of lateral load inducing test cells mechanically coupled, directly or indirectly, to the test stand,
wherein each set of lateral load inducing test cells comprises a load inducing structure or device, a guide, a load cell, and a clamp, wherein the set of lateral load inducing test cells are configured to couple, via the clamps, to a geosynthetic specimen; and
a controller coupled to the load cells of the set of lateral load inducing test cells, wherein the controller is configured to record load deformation response of the geosynthetic specimen.

2. The testing apparatus of claim 1 further comprising:
a soil box integrated into the test stand, the soil box having a boundary that defines a uniform load inducing test area for the geosynthetic specimen.

3. The testing apparatus of claim 2 further comprising:
a vertical load inducing test cell positioned over the soil box, the vertical load inducing test cell being configured to induce a vertical load within the boundary onto the uniform load inducing test area of the geosynthetic specimen.

4. The testing apparatus of claim 2 further comprising:
a contactless deformation measurement system positioned over the uniform load inducing test area for the geosynthetic specimen.

5. The testing apparatus of claim 4, wherein the contactless deformation measurement system comprises a camera and a controller configured to perform digital image correlation analysis of two or more images acquired by the camera.

6. The testing apparatus of claim 1 further comprising:
a movable frame having a set of arms, wherein a portion or all of the arms are movable with respect to each other, the set of lateral load inducing test cells being coupled an end of an arm.

7. The testing apparatus of claim 6, wherein the movable frame includes only a first arm, the first arm being configured with one or a pair of lateral load inducing test cells for uniaxial testing.

8. The testing apparatus of claim 7, wherein the movable frame further includes a second arm, the second arm being positionable with respect to the first arm, the second arm being configured with a second or a second pair of lateral load inducing test cells for biaxial testing.

9. The testing apparatus of claim 8, wherein the movable frame includes a third arm, the third arm being positionable with respect to the first arm and the third arm, the third arm being configured with a third or a third pair of lateral load inducing test cells for triaxial testing, and
wherein the first arm includes a center protrusion to receive the second arm and the third arm, wherein the second arm and third arm each has a central hole to be positioned onto the first arm, and wherein the first arm has a first thickness, the second arm has a second thickness, and the third arm having a third thickness to define a flush surface for respective placement of the set of lateral load inducing test cells.

10. The testing apparatus of claim 9, wherein the second arm and third arm are reconfigurable to different positions.

11. The testing apparatus of claim 1, wherein the test stand includes a first set of holes or slots to receive one or a pair of lateral load inducing test cells for uniaxial testing.

12. The testing apparatus of claim 11, wherein the test stand includes a second set of holes or slots to receive a second or a second pair of lateral load inducing test cells for biaxial testing.

13. The testing apparatus of claim 11, wherein the test stand includes a third set of holes or slots to receive a third or a third pair of lateral load inducing test cells for triaxial testing.

14. The testing apparatus of claim 1, wherein the soil box has a first geometry and is a part of a soil box system, the soil box system comprises a set of inserts that can be inserted into soil box to provide a second geometry, wherein the second geometry is different from the first geometry.

15. The testing apparatus of claim 14, wherein the soil box system includes a vertical load frame for a vertical load inducing test cell comprising a load piston and a load plate to apply loads to the geosynthetic specimen.

16. The testing apparatus of claim 1 wherein the set of lateral load inducing test cells are configured to apply loads monotonically to the geosynthetic specimen.

17. The testing apparatus of claim 1 wherein the set of lateral load inducing test cells are configured to apply loads cyclically to the geosynthetic specimen.

18. The testing apparatus of claim 1, wherein the set of lateral load inducing test cells comprises dead-weight systems comprising a dead weight, pulley, and cable.

19. The testing apparatus of claim 1, wherein the soil box includes natural geomaterial above and below the geosynthetic specimen.

20. The testing apparatus of claim 1, wherein the soil box includes man-made geomaterial above and below the geosynthetic specimen to investigate fundamental geosynthetic-geomaterial interactions.

21. The testing apparatus of claim 2, wherein the geosynthetic specimen is shaped to include a central region to be positioned in the soil box and extension region that extends from the central region.
